(19) United States
(12) Patent Application Publication
(10) Pub. No.: US 2008/0202341 A1
(43) Pub. Date: Aug. 28, 2008

(54) Gas Separation and Compression Device

(76) Inventors: John Edward Poole, Cheshire (GB); Richard Powell, Cheshire (GB)

Correspondence Address: BEYER WEAVER LLP, P.O. BOX 70250, OAKLAND, CA, 94612-0250, US

(21) Appl. No.: 11/883,101

(22) PCT Filed: Feb. 3, 2006
(86) PCT No.: PCT/GB06/00402

§ 371 Date: Feb. 29, 2008

(30) Foreign Application Priority Data
Feb. 3, 2005 (GB) 0502227.2

(51) Int. Cl. B01D 53/02; B01D 53/22; B01D 53/047

(52) U.S. Cl. 96/6; 96/4

(57) ABSTRACT

A gas separation device for separating a reactive gas from a gaseous mixture comprising porous anode and cathode electrodes separated by an ionic membrane,

the anode being impregnated with an absorbent compound or solvent;

the cathode being impregnated with an electrically conductive liquid;

a power supply for supplying electric charge to the electrodes;

an inlet for a gaseous mixture, the inlet communicating with a chamber adjacent the cathode;

and an outlet for gas from the chamber so that gas passing from the inlet to the outlet contacts the cathode;

wherein reactive gas is absorbed from the gaseous mixture by the absorbent compound and retained in the device and wherein the retained gas subsequently desorbed from the absorbent compound;

wherein the absorption, desorption or both are promoted by application of electric charge to the electrodes.

The invention relates to a device in which gas sorption and desorption on a porous solid are controlled by means of an electric field. The invention also relates to use of the device for gas separation, recovery, cooling and heat pumping.

Gas recovery and separation technologies are fundamental to the modem industrial world. Atmospheric gases are separated by cryogenic distillation on a multi-million tonne scale world-wide to provide oxygen and nitrogen and the noble gases argon, krypton and xenon. For some applications it is more convenient and economic to separate oxygen or nitrogen from air at point-of-use rather than transport cryogenically separated gases. Two technically distinct systems have been developed for this purpose.

One method is pressure swing adsorption (PSA) where air is compressed into a vessel containing a carbon molecular sieve, which can preferentially adsorb oxygen molecules onto its surface. The gas vented in a controlled release is initially greatly enriched in nitrogen compared to air. Towards the end of the process the vent gas is enriched in oxygen. By operating with two or more beds an essentially continuous supply of nitrogen and/or oxygen can be generated.

An alternative method involves the use of a microporous membrane that has a much greater permeability for oxygen, carbon dioxide and water vapour than for nitrogen. Oxygen passes through the membrane allowing nearly pure nitrogen to exit the end of the tube. Similarly carbon dioxide can be separated from nitrogen in flue gases from fossil fuel power stations. This facilitates the compression of carbon dioxide, enabling it to be sequestrated in geological formations rather being released to the atmosphere to contribute to anthropological global warming.

Because of their inherent nature diffusion separation methods relying upon adsorbents or membranes cannot achieve the high degrees of separation achievable by cryogenic distillation. Higher flow rates result in poorer separations. Furthermore, they cannot compress gases since they rely upon external gas compression to operate.

An alternative to pressure swing adsorption is thermal swing adsorption (TSA) where the gas mixture is passed over an adsorbent bed to remove the preferentially adsorbed component. When the bed is saturated the mixture flow is stopped and the bed heated to desorb the adsorbed component.

However the technology is relatively energy inefficient because it requires the cooling and heating of adsorbent packed beds. Electrically conducting carbon fibre composite molecular sieve (CFCMS) beds have been used to adsorb carbon dioxide. Desorption was achieved by passing an electric current through the adsorbent to heat it and the process is called “Electrical swing absorption” (ESA). Combined pressure and thermal swing adsorption technologies (PTSA) have also been described.

The technologies described above depend upon the separation of gases by adsorption on solids. The absorption of CO₂ and H₂S by various proprietary liquid amine mixtures is a well-established technology for purifying natural gas. This technology has been proposed for the removal of CO₂ from power station flues. Significant amounts of thermal energy are required to separate the CO₂ from the amine so that the later can be recycled. The more strongly, and thus the more efficiently, the amine absorbs the CO₂ the greater energy required subsequently for separation. Power stations have low temperature heat in the flue gas itself that could be used, but this is then degraded so is not available for power generation. A further disadvantage is that the gas is recovered at near-atmospheric pressure so must be compressed to facilitate sequestration. Again this requires energy thus further reducing the overall efficiency of the power station.

Gas separation technologies are also important in submarines, military vehicles and manned spacecraft. For example in submarines carbon dioxide has been removed by reaction with sodium peroxide simultaneously releasing more oxygen for respiration. In closed circuit anaesthesia carbon dioxide is removed by passing the re-cycled respiration gas over soda-lime. These technologies involve essentially irreversible chemical reactions.

According to the present invention there is provided a gas separation device for separating a reactive gas from a gaseous mixture comprising porous anode and cathode electrodes separated by an ionic membrane, the anode being impregnated with an absorbent compound or solvent, the cathode being impregnated with an electrically conductive liquid, a power supply for applying electric charge to the electrodes, an inlet for a gaseous mixture, the inlet communicating with a chamber adjacent the cathode, and an outlet for gas from the chamber so that gas passing from the inlet to the outlet contacts the cathode, wherein the reactive gas is absorbed from the gaseous mixture by the absorbent compound, retained in the device and subsequently desorbed from the absorbent compound, wherein the absorption, desorption or both, are promoted by application of electric charge to the electrodes.

In a one embodiment of the invention the reactive gas is absorbed when the electrodes are charged and the reactive gas is desorbed when the charge is removed. This may cause the reactive gas to be removed from the device in a concentrated stream.

In an alternative embodiment the gas is absorbed when the electrodes are uncharged and the gas is desorbed when the electrodes are charged. This may cause the reactive gas to be removed from the device in a concentrated stream.

In a further embodiment the gas is absorbed when the electrodes are charged to a first polarity and the gas is desorbed when the electrodes are charged to a reversed polarity to the first polarity. The gas may be removed from the device in a concentrated stream.

The reactive gas preferably carbon dioxide or ammonia. The reactive gas may be a combustion exhaust gas, for example from an electricity generation plant or power station.

When the reactive gas is carbon dioxide the absorbent compound is preferably selected from an amine, sulphonic acid or carboxylic acid. An oligomeric or polymeric amine, sulphonic acid or carboxylic acid is preferred. A bi-functional amine sulphonic acid or bi-functional amine carboxylic acid may be used, particularly 2-methane sulphonic acid.

When the reactive gas is ammonia the solvent or absorbent compound is preferably selected from:

water or aqueouos acid for example hydrochloric acid or other mineral acid.

In a preferred device the ionic membrane comprises an ionic polymer. Preferred ionic polymers are selected from: sulphonated polystyrene, sulphonated polyetherketone, sulphonated polyethersulphone, Nafion™ and fluorinated polymers.

Each electrode may be composed of porous carbon, for example in the form of an aerogel, nanotube, open celled sponge or woven fibres composition. Electrodes may have the configuration of porous sheets. Alternatively a cylindrical or tubular configuration may be employed.

The present invention, which seeks to overcome the limitations inherent in the technologies outlined above, is based on the use of electric fields in super-capacitor-like systems to control the reversible sorption and desorption of reactive gases, particularly by the transmission of protons (hydrogen ions) across an anionic membrane, or hydroxyl ions across a cationic membrane. The device preferably uses only non-Faradayic processes; i.e. electrode reactions involving electron transfer are avoided by operating at sufficiently low potential differences. The device can operate in any one of three modes. In a first mode the absorption is driven by the application of the electric field and the

desorption occurs when the field is removed because of the difference between the chemical potentials of the gas in its sorbed and desorbed states. In a second mode the gas sorbs from the gaseous state in the absence of the electric field because of the difference between the chemical potentials of the gas in its sorbed and desorbed states; desorption occurs when the electric field is applied. In a third mode the sorption of the gas is enhanced by the application of the electric field in one direction while desorption is enhanced by reversing the field.

The invention is further described by means of example but not in any limitative sense with reference to the accompanying drawings, of which:

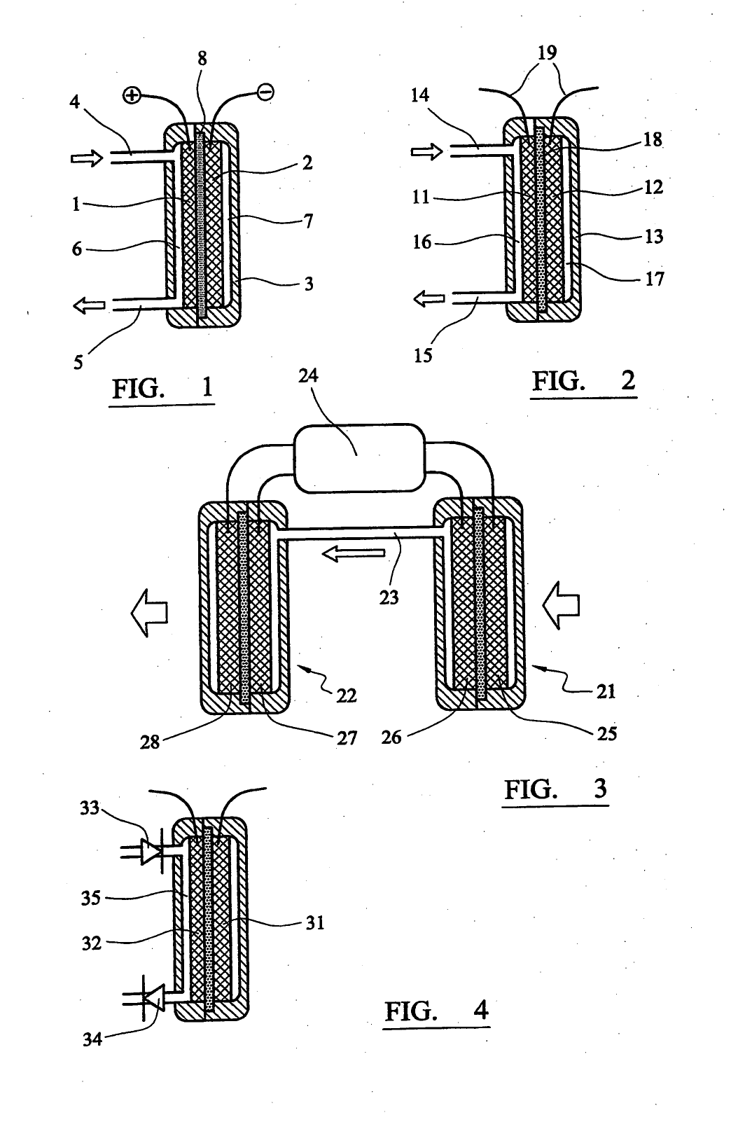

FIG. 1 illustrates a device in accordance with the invention used to separate a reactive gas;

FIG. 2 illustrates a device used to separate ammonia from air;

FIG. 3 illustrates two units connected to form a swing cycle unit for cooling or heating pumping;

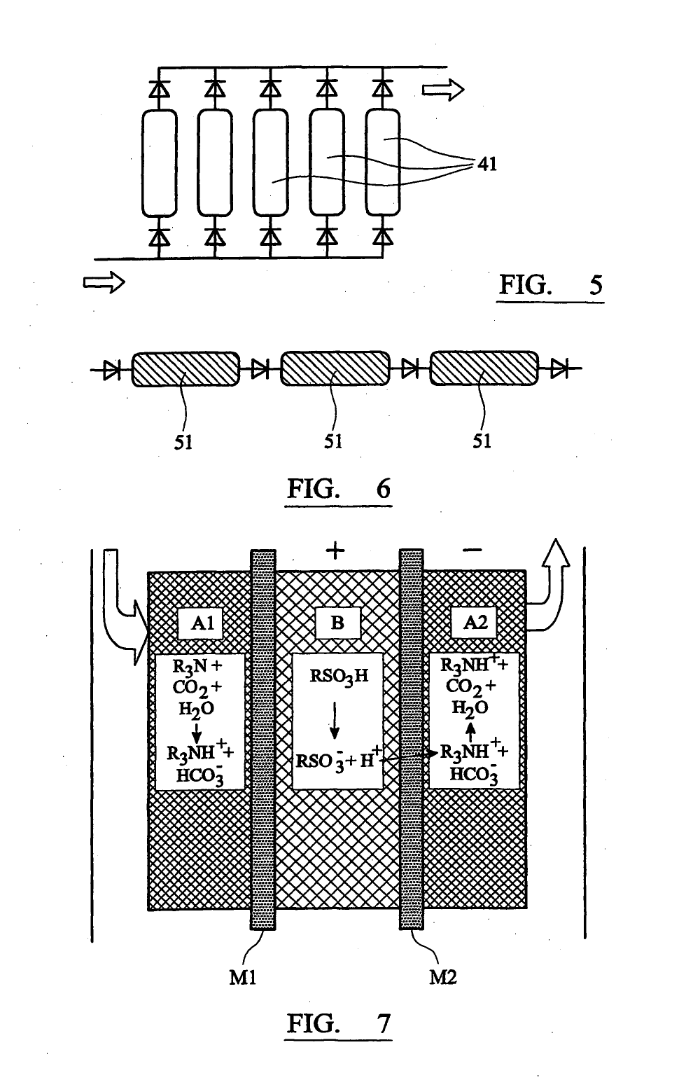

FIG. 4 illustrates a further embodiment of the invention;

FIG. 5 illustrates an embodiment with multiple units arranged in parallel;

FIG. 6 illustrates a multiple stage arrangement; and

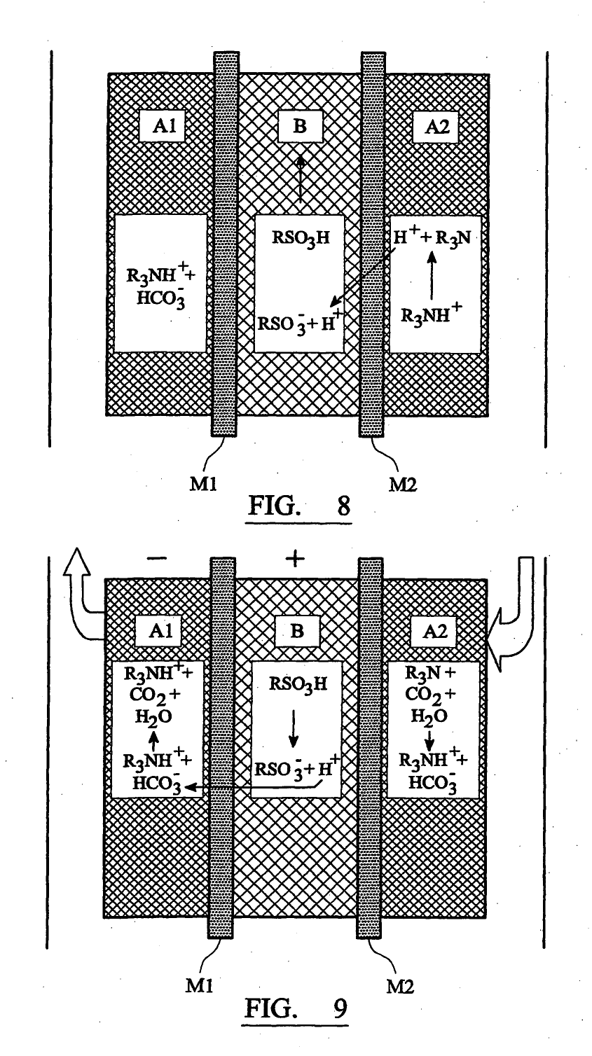

FIGS. 7 to 9 illustrate a swing bed arrangement for absorption of CO₂.

In a first embodiment of this invention shown in FIG. 1 the device is used to separate a reactive gas from non-reactive gases. For example carbon dioxide may be separated from other gases, particularly nitrogen or methane. The two electrodes (1, 2) may comprise conducting porous carbon sheets. The sheets may be similar to those used in fuel cells and super capacitors. One electrode (1) is impregnated with water and the other (2) with a high molecular weight, preferably polymeric, amine. The membrane carries anionic groups, which allow the passage of positively charged cations, notably hydrogen ions H⁺, under the influence of an electric field gradient. Preferred membranes include fluorinated membranes such as Nafion™, sulfonated polystyrene and sulfonated polyether and ether-ketone (e.g PEEK™). This arrangement enhances the solubility of CO₂ in the water. By discharging the cell, i.e. removing the charge from the electrodes, the solubility of the CO₂ is reduced allowing it to de-gas from the cell in a concentrated stream. The device is operated in Mode 1 as defined above.

The cell may be considered to operate as a capacitor, or more accurately as a super-capacitor. Since capacitors store and release electrical energy efficiently much of the input energy used to charge the cell during the CO₂ sorption will be recovered during desorption and can be used to power the sorption operation of a second cell. This process can be referred to as “capacitive swing adsorption” (CSA). A preferred arrangement consists of two or more beds operated in parallel to enable simultaneous CO₂ sorption and desorption.

The electrode reactions are the following.

Anode

The bicarbonate anion, HCO₃⁻, is attracted to the positively charged anode while the hydrogen

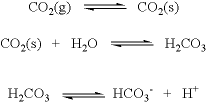

ion, H⁺, is attracted to the negatively charged cathode, which it is able reach by travelling through the anionic membrane.

Cathode

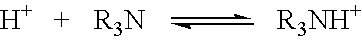

The equilibria at the anode are driven forward by the removal of the hydrogen ion. This enhances the amount of CO₂ dissolved.

The potential across the electrodes is less than that required for electrode reactions to occur. Typically the potential will be in the range from about 0.8 to about 1 v when water is present in the electrode. Electrode reactions would absorb energy and lead to the irreversible formation of new chemical species. However in embodiments in which gas separations are carried out in substantially water-free systems where the electrode is wetted with a non-aqueous solvent, such as propylene carbonate, potentials can be employed up to about 2 volts and more preferably up to about 2.7 volts.

The ability of the system to dissolve CO₂ is determined by the surface area of the porous carbon electrodes and thus to the extent of the electrical double layer which can be formed before potential limit is reached. The larger the surface area of the carbon the higher is its capacity for CO₂. Conducting carbon aerogels, carbon nanotubes or CFCMS are among the preferred electrode materials.

In another embodiment the device is used to separate ammonia from a gas mixture. FIG. 2 illustrates the device configured to remove ammonia from air. Two porous electrodes (11, 12) are arranged on opposite sides of a membrane (18), the assembly being located in a casing (13). Inlet (14) and outlet (15) ducts supply a gas mixture to a chamber (16) adjacent to the electrode (11). A second chamber (17) is disposed adjacent to the electrode (12). Conductors (19) are arranged to supply a potential difference across the electrodes (11, 12).

In use of the device the gas mixture is passed into the cell and ammonia dissolves in the water. The solubility of ammonia is promoted by transfer of hydroxyl ions across the membrane (18) driven by the potential difference across the electrodes (11, 12). When the cell is saturated with ammonia the flow of the gas mixture is stopped and the potential difference removed. When this occurs hydroxyl ions flow back across the membrane from the acid impregnated electrode to the water impregnated electrode resulting in the liberation of gaseous ammonia. However, even when there is no charge on the electrodes a substantial amount of ammonia will remain in solution. To promote dissolution a reverse potential may be applied across the cell. The cell is essentially working in Mode 3 as described above. Any acid may be used provided that the molecules are sufficiently large to inhibit diffusion across the membrane. Oligomeric and polymeric sulfonic and carboxylic acids are preferred. Especially preferred are bi-functional amino sulfonic and carboxylic acids such as taurine (2-aminoethanesulfonic acid) which can act as both acids and bases.

The electrode reactions during solution are the following.

Cathode

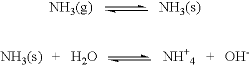

The hydroxyl ions pass through the cationic membrane to the anode.

Anode

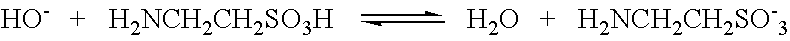

When the reverse potential is applied the following electrode reactions occur.

Cathode

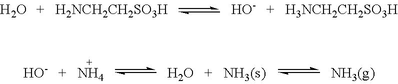

Anode

In a further embodiment two or more cells may be linked to form a swing cycle unit for cooling or heat pumping. A first cell (21) and second cell (22) are connected by a gas conduit (23). A power supply (24) is arranged to alternatively charge and discharge the electrodes (25, 26, 27, 28) so that heat is absorbed by one cell while heat is given out by the other cell from a heat pump. During sorption the heat of reaction of CO₂ is generated raising the temperature of the cell. During desorption the heat will be taken in. In the system shown in FIG. 3 the first cell (21) is being heated and the second cell (22) is being cooled. When the first cell (21) is saturated with CO₂ the power pack discharges the first cell (21) and charges the second cell (22). The gas flow is reversed, the first cell (21) now takes in heat and the second cell (22) gives out heat.

In another embodiment one electrode (31) may be impregnated with an amine and the other (32) with sulfonic acid as shown in FIG. 4. In this embodiment valves (33, 34) are provided to control the inlet and outlet gas flows from the chamber (35). The operation of the device in this configuration is analogous to mechanical positive displacement compressors, such as reciprocating or rotary vane types. It can be described as an “electro-desorption compressor” (EDC) since the sorption is driven just by the difference between the chemical potential of CO₂ in the gaseous and absorbed states, while the desorption is driven by the applied electrical potential. The following description of the steps of EDC operation starts from the point where CO₂ has just finished discharging and the potential across the electrodes has been removed.
Step 1. Residual CO₂ in the compressor sorbs onto electrode A by reaction with the amine. This reduces the pressure causing the discharge valve to close and the inlet valve to open. (This maybe considered to be equivalent to beginning of the suction stroke of a reciprocating compressor.)
Step 2. Low pressure CO₂ enters through the suction valve and is sorbed by the amine. This is an exothermic reaction. In this instance the process may be carried out near-isentropically with thermal mass of the electrode-membrane assembly limiting the rise in temperature. (This is equivalent to the suction stroke of a reciprocating compressor.)
Step 3. When the sorption is complete, a potential difference of 0.8-1 V is applied across the electrodes (A negative and B positive). Hydrogen ions are driven across the membrane from B to A where they cause desorption of CO₂. The pressure rises, the inlet valve closes and the discharge valve opens releasing gas into the high pressure side of the circuit. (This is equivalent to the compression stroke of a reciprocating compressor.) Desorption of CO₂ is assumed to be near-isentropic so the heat of desorption is supplied by the thermal mass of the EDC which was already heated during the sorption phase.
Step 4. The energy on the electrodes may be recovered by an appropriate electrical circuit and either stored in a capacitor bank or transferred to a second EDC unit undergoing desorption. The difference between energy required to charge the device against the CO₂ pressure and the energy recovered during discharge in absence of a CO₂ back pressure is the energy required to drive the device.

The device is operating essentially in Mode 2 as described above.

An EDC has the following advantages over a conventional mechanical positive displacement compressor.

There are no moving parts, apart from the valves, eliminating frictional and other mechanical losses.

There are relatively long cycle times typically 0.5 to tens of seconds compared with <0.1 seconds for the cycle times of reciprocating compressors, so valves will be more durable.

No lubricant is needed, avoiding return problems or adverse effects on heat exchange in other parts of the circuit.

The EDC is oil free and therefore especially suited to driving a cooling or heat pump system.

There are fewer geometrical constraints on shape and positioning. The device may be fat and cylindrical or flat and rectangular according to the available space. Orientation can be varied since there is no oil sump to consider.

Multiple units (41) can be arranged in parallel as shown in FIG. 5. An advantage of this configuration is that the capacity of the cooling unit can be varied by selecting the number of units utilised, without incurring the mechanical losses experienced in reciprocating machines when cylinders are by-passed to reduce capacity. Should more capacity be required from an existing installation more EDC compressors units can be added. A further advantage is that the units shown in FIG. 4 can be phased so that a near constant delivery of compressed CO₂ is provided analogous to the operation of mechanical multi-cylinder reciprocating compressor. To ensure good energy efficiency the electric charge may be transferred from a unit sorbing CO₂ to a unit desorbing CO₂.

The capacity delivered by an individual EDC can be controlled both by varying the maximum applied potential and/or the rate at which the potential is applied. The former corresponds to changing the stroke of a reciprocating compressor, which is not easily done, and the latter to changing its speed.

Compressors (51) in accordance with this invention can be readily multi-staged by operating in series to provide larger pressure differences than can be covered by a single unit as shown in FIG. 6. The system can be further elaborated by using interstage cooling.

In a further configuration both series and parallel compressors may be arranged in thermal contact so that one heats up as CO₂ an adjacent unit cools as the result of desorption.

The operation of the compressor of this invention may be near isentropic, i.e. similar to a mechanical compressor. Operating such a compressor under near-isothermal conditions can be advantageous, for example capacity may be increased. With the conventional mechanical compressors typically employed for refrigeration and air conditioning it is very difficult to remove the heat of compression. In contrast when using an EDC this can readily be achieved. The device may be designed for isothermal operation by configuring it as a finned plate having good heat exchange capabilities.

In a further embodiment energy efficiency may be enhanced by utilising the heat of absorption at one electrode to supply the heat of desorption at an adjacent electrode as shown in FIG. 7. The outer electrodes, A1 and A2, are, for example amine impregnated high surface area carbon. They are separated from the inner electrode B by anionic membranes M1 and M2. Electrode B is, for example, a high surface area graphite or porous carbon electrode impregnated with a sulfonic acid. The amine and the sulfonic acid materials are preferably essentially immobile when the electric field is applied. The

FIGS. 7 to 9 show the device being used to remove CO₂ from flue gas. The device may also be applied to the removal of CO₂ from natural gas, the atmosphere in a submarine or spacecraft, and other similar applications.

By changing the potential across the electrode assembly it may operate as a swing bed for CO₂ sorption/desorption. In FIG. 7 CO₂ from a flue gas is sorbed from a flue gas by the amine on electrode A1, using the same type of chemistry as in a conventional amine scrubbing plant. Simultaneously, a potential is applied across electrodes B and A2 to cause hydrogen ions to move from B to A2 across the anionic membrane. In A2 the hydrogen ions protonate the bicarbonate anion (HCO₃⁻) generated from a previous sorption to release CO₂. B/membrane/A2 may be considered to constitute a super-capacitor. This can be charged to a maximum of ˜1 volt. A higher voltage may produce irreversible electrode reactions. In FIG. 8 the potential has been removed from across electrodes B and A2, i.e. the capacitor has been discharged, resulting in the transfer of hydrogen ions across the membrane M2 from A2 to B to provide electrical neutrality. In FIG. 9 the potential is applied across B and A1 so that A1 now discharges CO₂ and A1 sorbs it. By discharging the super-capacitor A1/M1/B and then starting to recharge the super-capacitor B/M2/A2 the system is returned to situation shown in FIG. 7.

This embodiment has significant advantages over existing technologies for CO₂ removal from gas streams. Simultaneously adsorbing and desorbing CO₂ on different electrodes within the same electrode assembly allows the heats of adsorption and desorption to counter-balance each other. This provides good energy efficiency at the same time avoiding the cost of installing separate heat exchangers that would be required by a conventional amine absorption system. Likewise the electrical energy involved in charging the cell can largely be recovered by using a discharging cell to assist the charging of a second cell.

1. A gas separation device for separating a reactive gas from a gaseous mixture comprising porous anode and cathode electrodes separated by an ionic membrane,
the cathode being disposed in a chamber;
the anode being impregnated with an absorbent compound or solvent;
the cathode being impregnated with an electrically conductive liquid;
a power supply for supplying electric charge to the electrodes;
an inlet for a gaseous mixture the inlet communicating with a chamber adjacent the cathode;
and an outlet for gas from the chamber so that gas passing from the inlet to the outlet contacts the cathode,
wherein reactive gas is absorbed from the gaseous mixture by the absorbent compound and retained in the device and wherein the retained gas subsequently desorbed from the absorbent compound;
wherein the absorption, desorption or both are promoted by application of electric charge to the electrodes.

2. A device as claimed in claim 1 wherein the reactive gas is absorbed when the electrodes are charged and wherein the reactive gas is desorbed when the electrodes are discharged.

3. A device as claimed in claim 1 wherein the reactive gas is absorbed when the electrodes are uncharged and wherein the reactive gas is desorbed when the electrodes are charged.

4. A device as claimed in claim 1 wherein the reactive gas is absorbed when the electrodes are charged to a first plurality and wherein the reactive gas is desorbed when the electrodes are charged to a reversed plurality to the first plurality.

5. A device as claimed in claim 1 wherein the absorbent compound is selected from the group consisting of amines, sulphonic acids or carboxylic acids and mixtures thereof or wherein the solvent is water or aqueous acid.

6. A device as claimed in claim 5 wherein the absorbent compound is an oligomeric or polymeric amine, sulphonic acid or carboxylic acid.

7. A device as claimed in claim 5 wherein the absorbent compound is a bi-functional amine sulphonic acid or bi-functional amine carboxylic acid.

8. A device as claimed in claim 7 wherein the absorbent compound is 2-methane sulphonic acid.

9. A device as claimed in claim 1 wherein the ionic membrance comprises an ionic polymer.

10. A device as claimed in claim 9 wherein the ionic polymer is selected from the group consisting of:
sulphonated polystyrene, sulphonated polyetherketone, sulphonated polyethersulphone, Nafion and fluorinated polymers.

11. A device as claimed in claim 1 wherein the gas is carbon dioxide.

12. A device as claimed in claim 11 wherein the gas is an exhaust from the combustion flue.

13. A device as claimed in claim 1 wherein the gas is ammonia.

14. A device as claimed in claim 1 wherein the cathode is impregnated with water.

15. A device as claimed in claim 1 wherein the potential across the electrodes during gas absorption is about 0.81 v.

16. A device as claimed in claim 1 wherein the electrodes are composed of porous carbon.

17. A device as claimed in claim 16, wherein the electrodes are composed of carbon aerogel or high surface area graphite.

18. A gas separation device or compressor comprising a plurality of devices as claimed in claim 1 coupled to form a swing cycle arrangement.

19. A device as claimed in claim 18, wherein both devices have anodes impregnated with the same compound.

20. A device as claimed in claim 18, wherein the both devices have anodes impregnated with different compounds.

21. A device as claimed in claim 20, wherein a first anode is impregnated with an amine and a second anode is impregnated with a sulphonic acid.

22. A swing cycle unit for cooling or heat pumping, formed by two or more linked cells, wherein each cell comprises a gas separation device for separating a reactive gas from a gaseous mixture,
comprising porous anode and cathode electrodes separated by an ionic membrane;
the cathode being disposed in a chamber;
the anode being impregnated with an absorbent compound or solvent; the
cathode being impregnated with an electrically conductive liquid; a
power supply for supplying electric charge to the electrodes;
an inlet for a gaseous mixture the inlet communicating with a chamber adjacent the cathode;
and an outlet for gas from the chamber so that gas passing from the inlet to the outlet contacts the cathode;
where carbon dioxide as the reactive gas is absorbed from the gaseous mixture by the absorbent compound and retained in the device and wherein the retained gas is subsequently desorbed from the absorbent compound;
wherein the absorption, desorption or both are promoted by application of electric charge to the electrodes;
wherein the power supply is configured to alternatively charge and discharge the electrodes so that heat is absorbed from one cell while heat is given out by another of said cells.

23. A unit as claimed in claim 22 wherein the reactive gas is absorbed when the electrodes are uncharged and wherein the reactive gas is desorbed when the electrodes are charged.

24. A unit as claimed in claim 22 wherein the reactive gas is absorbed when the electrodes are charge to a first polarity and wherein the reactive gas is desorbed when the electrodes are charged to a reversed polarity to the first polarity.

25. A unit as claimed in claim 22 wherein the absorbent compound is selected from the group consisting of amines and mixtures thereof or wherein the solvent is water or aqueous acid.

26. A unit as claimed in claim 25 wherein the absorbent compound is an oligomeric or polymeric amine, sulphonic acid or carboxylic acid.

27. A unit as claimed in claim 25 wherein the absorbent compound is a bi-functional amine sulphonic acid or bi-functional amine carboxylic acid.

28. A unit as claimed in claim 22 wherein the ionic membrane comprises an ionic polymer.

29. A unit as claimed in claim 28 wherein the ionic polymer is selected from the group consisting of:
sulphonated polystyrene, sulphonated polyetherketone, sulphonated polyethersulphone, Nation and fluorinated polymers.

30. A device as claimed in claim 22 wherein the gas is an exhaust from the combustion flue.

31. A unit as claimed in claim 22 wherein the cathode is impregnated with water.

32. A unit as claimed in claim 22 wherein the potential across the electrodes during gas absorption is about 0.81 v.

33. A unit as claimed in claim 22 wherein the electrodes are composed of porous carbon.

34. A unit as claimed in claim 33 wherein the electrodes are composed of carbon aerogel or high surface area graphite.

35. A unit as claimed in claim 22 wherein both devices have anodes impregnated with the same compound.

36. A unit as claimed in claim 22 wherein the both devices have anodes impregnated with different compounds.

37. A unit as claimed in claim 36 wherein a first anode is impregnated with an amine and a second anode is impregnated with a sulphonic acid.

38. A cooling or heat pumping unit comprising two or more cells connected to a gas conduit,
each cell comprising porous anode and cathode electrodes separated by an ionic membrane,
the anode being impregnated with an absorbent compound or solvent,
the cathode being impregnated with an electrically conductive liquid,
an inlet for a gaseous mixture containing carbon dioxide as a reactive gas,
the inlet communicating with a chamber adjacent the cathode,
a power supply arranged to alternately charge and discharge the electrodes so that heat is absorbed by one cell while heat is given out by the other cell.

39. A unit as claimed in claim 38 wherein the electrode reactions are non-Faradayic.
